(19) United States
(12) Patent Application Publication
(10) Pub. No.: US 2020/0041700 A1
(43) Pub. Date: Feb. 6, 2020

(54) OPTICAL LENS AND OPTICAL CAMERA LENS

(71) Applicant: AAC Technologies Pte. Ltd., Singapore city (SG)

(72) Inventor: Hailong Wang, Shenzhen (CN)

(21) Appl. No.: 16/525,612

(22) Filed: Jul. 30, 2019

(30) Foreign Application Priority Data
Aug. 4, 2018 (CN) 201821261949.7

(51) Int. Cl. G02B 3/04

(52) U.S. Cl. CPC G02B 3/04; G02B 2003/0093

(57) ABSTRACT

The present disclosure provides an optical lens and an optical camera lens. The optical lens includes: an optical portion at a central position; a peripheral portion surrounding the optical portion; and a bearing portion. The peripheral portion includes an object-side surface facing an object side, an image-side surface facing an image side, and a side surface around an optical axis connecting the object-side surface with the image-side surface. The side surface includes a gate portion and a distal end portion facing right towards the gate portion in a radial direction of the optical lens. The bearing portion extends from the image side surface towards the image side. On a plane perpendicular to the optical axis, an orthographic projection of the bearing portion is located between an orthographic projection of the gate portion and an orthographic projection of the distal end portion.

### TECHNICAL FIELD

The present disclosure relates to the field of optical imaging technologies, and in particular, to an optical lens and an optical camera lens.

### BACKGROUND

With the continuous development of technology, electronic devices become more and more intelligent. In addition to digital cameras, portable electronic devices such as tablet PC and mobile phones are also equipped with lens modules having a photographing function in order to meet the users' requirements to take photos at any time. In the related art, a camera lens module includes a lens barrel and a plurality of optical lenses stacked in series and received in the lens barrel.

The inventors have found that at least the following problems exist in the related art. In the molding process of the optical lens, the opposite side of the gate is finally formed, and sometimes the opposite side of the gate is under-molded and the molding near the gate is over-molded, resulting in that the surface of the lens is uneven at the gate and at a position opposite to the gate and then resulting in unevenly bearing in the optical lens, so that the assembly stability of the optical lens is not high. Therefore, it is necessary to provide a new camera lens module to solve the above problems.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a top plan view of an optical lens according to a first embodiment of the present disclosure;

FIG. 2 is a side view of an optical lens according to a first embodiment of the present disclosure; and

FIG. 3 is a cross-sectional view of an optical lens according to a second embodiment of the present disclosure.

### DESCRIPTION OF EMBODIMENTS

The present disclosure will be further illustrated with reference to the accompanying drawings and the embodiments.

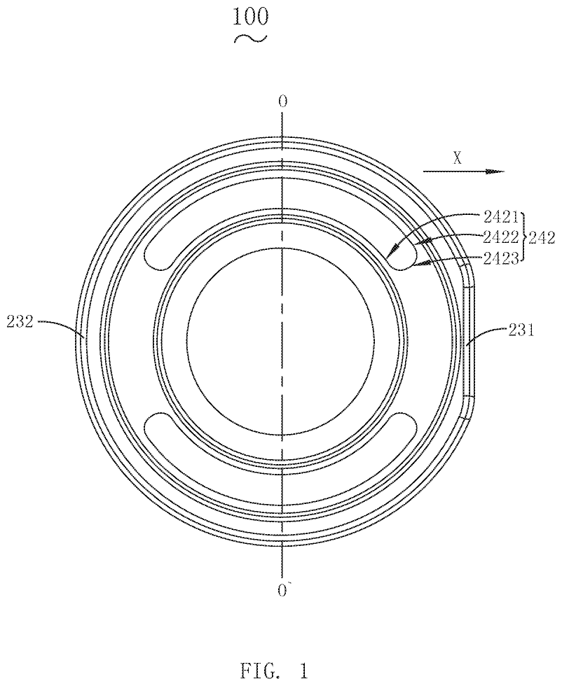

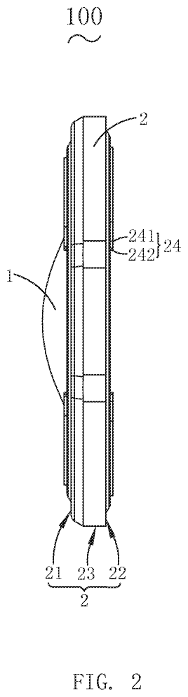

A first embodiment of the present disclosure provides an optical lens 100 shown in FIGS. 1 and 2.

The optical lens 100 includes an optical portion 1 at a central position and a peripheral portion 2 surrounding the optical portion 1. The peripheral portion 2 includes an object-side surface 21 facing the object side, an image-side surface 22 facing the image side, a side surface 23 around the optical axis OO′ connecting the object-side surface 21 with the image-side surface 22. The side surface 23 includes a gate portion 231 and a distal end portion 232 facing right towards the gate portion 231 in a radial direction (X direction in FIG. 1) of the optical lens 100. The optical lens 100 further includes a bearing portion 24 extending from the image-side surface 22 towards the image side. On a plane perpendicular to the optical axis OO′, an orthographic projection of the bearing portion 24 is located between an orthographic projection of the gate portion 231 and an orthographic projection of the distal end portion 232.

Compared with the related art, in this embodiment, the optical lens 100 further includes a bearing portion 24 extending from the image-side surface 22 towards the image side. On a plane perpendicular to the optical axis OO′, an orthographic projection of the bearing portion 24 is located between an orthographic projection of the gate portion 231 and an orthographic projection of the distal end portion 232. With this structure, the bearing portion 24 is close to the gate portion 231 during the molding process of the optical lens 100, so that the bearing portion 24 is close to the gate portion 231 after the molding process, thereby leading to a smaller height difference for the surface of the bearing portion 24. When being assembled, the optical lenses 100 abut against each other through the bearing portion 24, instead of through the gate portion 231 and the distal end portion 232 which have a large difference in height, thereby effectively avoiding the problem of “unevenly bearing between two adjacent optical lenses 100 caused by under-molding of distal portion 232 and over-molding of the gate portion”. Therefore, the assembly stability of the optical lens 100 is high, thereby improving the assembly yield of the optical lens and ensuring the optical performance of an optical camera lens having such an optical lens.

In one embodiment, the bearing portion 24 includes an end surface 241 facing away from the image-side surface 22, and a side wall 242 extending from the end surface 241 to the image-side surface 22. The sidewall 242 includes a first surface 2421 close to the optical axis OO′, a second surface 2422 opposite to the first surface 2421 and a third surface 2423 connecting the first surface 2421 with the second surface 2422.

It can be understood that, in this embodiment, each of the first surface 2421 and the second surface 2422 is an arc surface around the optical axis OO′. Since the inner circumference and the outer circumference of the optical lens 100 are also round surfaces, this arrangement can increase a contact area between the bearing portion 24 and the image-side surface 22. That is, the bearing portion 24 can be set bigger. When two lenses abut against each other, the bearing portion 24 having a larger area can further improve the assembly stability of the optical lens 100.

It should be noted that the third surface 2423 may also be an arc surface.

It should be noted that in the present embodiment, a plurality of bearing portions 24 is provided, and the plurality of bearing portions 24 is equally spaced around the optical axis OO′. In the optical lens 100 of such a structure, even if the bearing portion 24 has a low a height at a position facing away from the one end of the gate portion 231, the bearing portion 24 has a substantially uniform height at positions close to the gate portion is, thereby further reducing the influence caused by the uneven surface of the molded bearing portion 24.

Optionally, two bearing portions 24 may be provided. The two bearing portions 24 are equally spaced around the optical axis OO′. The two bearing portions 24 have same sizes and shapes. It will be appreciated that such an arrangement further avoids providing the bearing portion at the distal end portion 232. Orthographic projections of the two bearing portions 24 are located between an orthographic projection of the gate portion 231 and an orthographic projection of the distal end portion 232, and are away from the gate portion 231 and the distal end portion 232, so that each position of the bearing portion 24 is closer to the gate portion 231. Therefore, the molded bearing portion 24 will not have an uneven surface due to a certain position far away from the gate portion 231, thereby further improving the assembly stability of the optical lens.

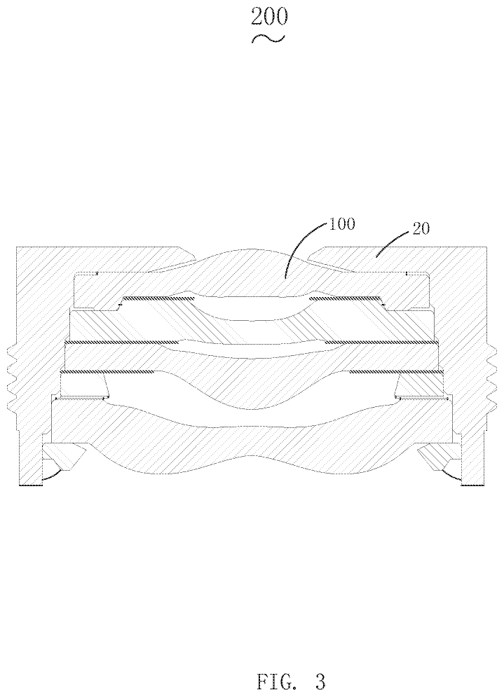

A second embodiment of the present disclosure provides an optical camera lens 200. As shown in FIG. 3, the optical camera lens 200 includes the optical lens 100 described above, and a lens barrel 20 receiving the optical lens 100.

The above are only preferred embodiments of the present disclosure. Here, it should be noted that those skilled in the art can make modifications without departing from the inventive concept of the present disclosure, but these shall fall into the protection scope of the present disclosure.

What is claimed is:

1. An optical lens, comprising:
an optical portion at a central position;
a peripheral portion surrounding the optical portion; and
a bearing portion,
wherein the peripheral portion comprises an object-side surface facing an object side, an image-side surface facing an image side, and a side surface around an optical axis connecting the object-side surface with the image-side surface; the side surface comprises a gate portion and a distal end portion facing right towards the gate portion in a radial direction of the optical lens; the bearing portion extends from the image side surface towards the image side; and, on a plane perpendicular to the optical axis, an orthographic projection of the bearing portion is located between an orthographic projection of the gate portion and an orthographic projection of the distal end portion.

2. The optical lens as described in claim 1, wherein the bearing portion comprises an end surface facing away from the image-side surface, and a side wall extending from the end surface to the image-side surface; the side wall comprises a first surface close to the optical axis, a second surface opposite to the first surface, and a third surface connecting the first surface with the second surface.

3. The optical lens as described in claim 2, wherein each of the first surface and the second surface is an arc surface around the optical axis.

4. The optical lens as described in claim 3, wherein the third surface is an arc surface.

5. The optical lens as described in claim 1, wherein a plurality of bearing portions is provided, and the plurality of bearing portions is equally spaced around the optical axis.

6. The optical lens as described in claim 5, wherein the plurality of bearing portions has identical sizes and shapes.

7. The optical lens as described in claim 6, wherein two bearing portions are provided.

8. An optical camera lens, comprising the optical lens as described in claim 1.

9. The optical camera lens as described in claim 8, wherein the bearing portion comprises an end surface facing away from the image-side surface, and a side wall extending from the end surface to the image-side surface; the side wall comprises a first surface close to the optical axis, a second surface opposite to the first surface, and a third surface connecting the first surface with the second surface.

10. The optical camera lens as described in claim 9, wherein each of the first surface and the second surface is an arc surface around the optical axis.

11. The optical camera lens as described in claim 10, wherein the third surface is an arc surface.

12. The optical camera lens as described in claim 8, wherein a plurality of bearing portions is provided, and the plurality of bearing portions is equally spaced around the optical axis.

13. The optical camera lens as described in claim 12, wherein the plurality of bearing portions has identical sizes and shapes.

14. The optical camera lens as described in claim 13, wherein two bearing portions are provided.
